(19) United States
(12) Patent Application Publication
(10) Pub. No.: US 2005/0232410 A1
(43) Pub. Date: Oct. 20, 2005

(54) Routing an outbound telephone call

(76) Inventor: Edward L. Gonzalez, Parkland, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/062,645

(22) Filed: Feb. 22, 2005

Related U.S. Application Data
(60) Provisional application No. 60/563,368, filed on Apr. 19, 2004.

(51) Int. Cl. H04M 3/00; H04M 5/00

(52) U.S. Cl. 379/266.08

(57) ABSTRACT

A system for routing outbound telephone calls between an outbound call workgroup and a third party is disclosed, including a predictive dialer configured to dial a first outbound telephone call, the predictive dialer configured and arranged to route the first outbound telephone call placed by the predictive dialer to an outbound call workgroup after a first voice authentication, the outbound call workgroup performing a second voice authentication, wherein the outbound call workgroup identifies a right-party contact on the first outbound telephone call based upon the second voice authentication, and wherein the predictive dialer dials a second outbound telephone call to the third party once the right-party contact on the first outbound telephone call is available to talk to the third party, and wherein the second outbound telephone call places the outbound call workgroup, the third party, and the right-party contact in communication with one another.

### CROSS-REFERENCE TO RELATED APPLICATIONS

This application claims the benefit of U.S. provisional patent application Ser. No. 60/563,368, filed on Apr. 19, 2004.

### TECHNICAL FIELD OF THE INVENTION

The present invention relates to telephone systems. In particular, the present invention relates to automated telephone systems and predictive dialers for establishing right-party contacts.

### BACKGROUND

The global marketplace is becoming more open and more efficient at providing goods and services. In the collection and telemarketing industries, firms use a call-handling station as the crucial link between the firms and the person being contacted. Efficiently establishing contact with a right-party as opposed to another person at the same telephone number (e.g., a family member, a babysitter, or a maid) helps reduce costs. Right-party contact systems for establishing contact with the targeted individual have long been known in the art. Typically these firms use call-handling stations to place outbound calls, receive inbound calls, ask for right parties, leave messages, return calls, and conduct business with the right parties. The call-handling stations are segregated into groups, groups are assigned to handle specific call types arriving or leaving on telephone trunk lines, and trunk lines are designated for particular purposes such as support, sales, and collections.

One significant disadvantage of these existing call-center environments is that as few as ten percent of the calls result in contact with the right-party. Thus, the person manning the call-handling station spends most of his/her time trying to reach the right-party rather than conducting business with the right-party. As a result, the calling system requires a large staff to handle a significant volume of calls. A related problem is that the system requires call-handling equipment for each call-handler. The result is high overhead for wages, benefits, training, equipment, and the like.

Therefore, there is a need for a call-center environment that increases efficiency and reduces costs to the firms. There is also a related need for a telephone system that reduces the amount of time that call-handlers spend handling calls. There is yet another need for a way to track the efficiency and productivity of the call-handlers. Increasing call-handling efficiency and productivity would result in lower personnel and facility costs to the firms.

### SUMMARY OF THE INVENTION

The present invention eliminates the above-mentioned needs for a call handling system by providing a call handling system and method that routes outbound telephone calls between an outbound call workgroup and a third party.

In accordance with the present invention, there is provided a system for routing outbound telephone calls between an outbound call workgroup and a third party, including a predictive dialer configured to dial a first outbound telephone call, the predictive dialer configured and arranged to route the first outbound telephone call placed by the predictive dialer to an outbound call workgroup after a first voice authentication, the outbound call workgroup performing a second voice authentication, wherein the outbound call workgroup identifies a right-party contact on the first outbound telephone call based upon the second voice authentication, and wherein the predictive dialer dials a second outbound telephone call to the third party once the right-party contact on the first outbound telephone call is available to talk to the third party, and wherein the second outbound telephone call places the outbound call workgroup, the third party, and the right-party contact in communication with one another.

### BRIEF DESCRIPTION OF THE FIGURES

FIG. 1 is a flow chart diagrammatic illustration of an overview of the preferred embodiment of the present invention.

FIG. 2 is a flow chart diagrammatic illustration of the steps of call routing in accordance with the present invention of FIG. 1.

FIG. 3 is an additional flow chart diagrammatic illustration of an overview of the present invention of FIG. 1.

### DETAILED DESCRIPTION OF THE INVENTION

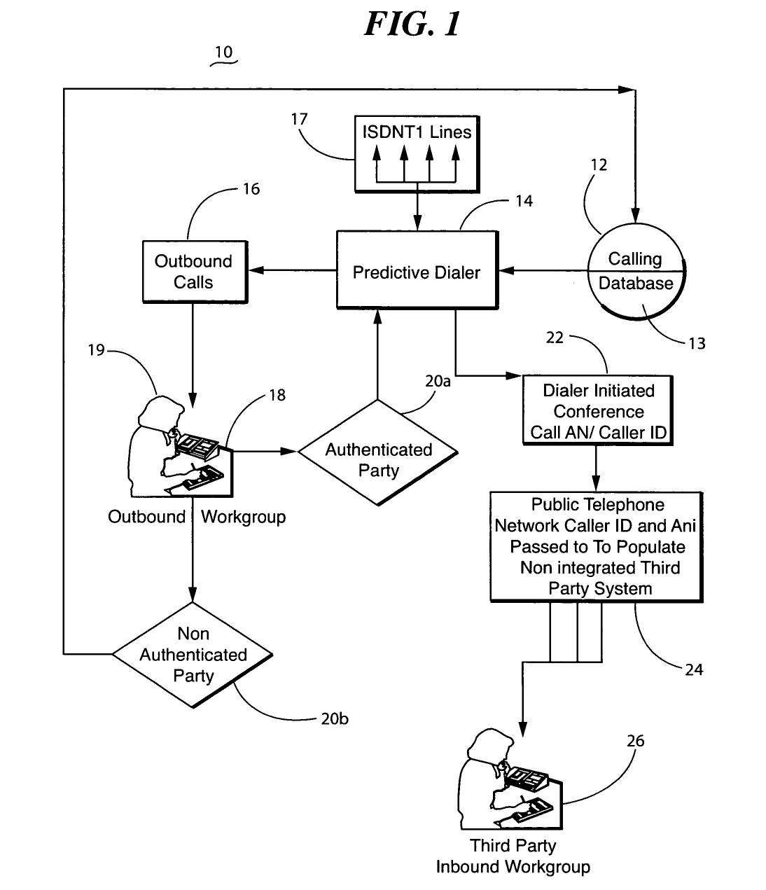

Referring now to FIG. 1, a representative embodiment of the present invention is illustrated as call routing system 10. Call routing system 10 includes a calling database 12, a predictive dialer 14, and an outbound workgroup 18.

As is shown in FIG. 1, calling database 12 is in electronic communication with predictive dialer 14. Calling database 12 may be a software application that is run on a computer. Such application software is loaded into memory from a storage medium, such as a hard drive, and contains data related to right-party customers (as detailed below) of a third party. Calling database 12 can hold data 13 related to personal information of a right-party customer, including but not limited to, the right-party contact's name, address, telephone number, and account information, security codes, and the like (also referred to as automatic number identification or ANI information herein).

Calling database 12, using data 13 contained therein, electronically transmits a telephone number to be dialed by predictive dialer 14. Predictive dialer 14 receives data 13, such as telephone numbers, or, alternatively, retrieves telephone numbers and corresponding account information (data 13) from the database 12 and automatically dials the telephone number over ISDN T1 lines 17. Placing outbound calls 16 over ISDN T1 lines 17 permits data 13 to be uniquely coded. Thus, as detailed below, the uniquely coded data 13 can ultimately be transmitted to a third party inbound workgroup 26, so as to permit third party inbound workgroup 26 to retrieve its own right-party data record in order to match a right party voice with its data records.

Using ISDN T1 lines 17 allows for two ten-digit fields to be employed. The first ten-digit field allows for a first ten-digit number, such as a caller identification number, to be transmitted through call routing system 10. The second ten-digit field allows for a second ten-digit number to be created that codes for the right-party's account information and is used to transmit coded account information relating to the right-party to a non-integrated third party system.

By way of example, if the right-party has a fifteen-digit alpha-numeric account number, such as a policy number identification for insurance through a client insurance company, then call routing system 10 will create a cross-reference table to assign a ten-digit code specific to that particular fifteen-digit alpha-numeric account number. The cross-reference table is further provided to the client insurance company. After the right-party contact is established, as detailed below, the ten-digit code specific to that particular fifteen-digit alphanumeric account number is transmitted to the client insurance company. Using the cross-reference table previously provided, the client insurance company's database cross-references the transmitted ten-digit coded account information to identify the particular fifteen-digit alphanumeric account number that relates to the insured right-party. In this way, account information for a right-party account holder can be easily coded and decoded so as to permit both transmission over ISDN T1 lines 17 and a more secure method of data transmission. In another embodiment, the two ten-digit numbers are combined to create a 20-digit (or fewer) code. For example, the first four digits can be used as a means for the third-party to route the call as it would otherwise route a call based on a DNIS code. The remaining six digits could then be combined with the next ten digits to code a credit cardholder's number for retrieval of a credit cardholder's account information.

If the predictive dialer 14 makes a connection with the telephone number dialed, the predictive dialer 14 routes outbound call 16 and corresponding account information from the database 12 to outbound workgroup 18. In this manner, the voice information and the database information are simultaneously communicated to outbound workgroup 18. A call handler 19 of outbound workgroup 18 is responsible for establishing right-party contact at the connected telephone number, skip tracing, data corrections, and leaving messages. Call handler 19 can then update data 13 of database 12 with notes on any conversation, updated telephone numbers, updated addresses, and the like.

Call handler 19 of outbound workgroup 18 will ask the party who answered outbound call 16 if the right party is available to speak to call handler 19. If the right party is not available, call handler 19 discontinues outbound call 16. If the right party is available to speak to call handler 19, call handler 19 will ask the party a series of questions designed to authenticate the party as the right-party contact. If call handler 19 fails to obtain appropriate responses to the series of questions, the party is deemed to be a non-authenticated party 20b. A determination that the party is a non-authenticated party 20b results in outbound call 16 being terminated and database 12 placing that telephone number (and associated information) back into a list of telephone numbers to be dialed by predictive dialer 14.

If call handler 19 obtains appropriate responses to the series of questions, the party is deemed to be an authenticated party 20a. A determination that the party is an authenticated party 20a results in outbound call 16 being electronically routed back to predictive dialer 14.

Predictive dialer 14 then initiates a second outbound call (conference call 22) over a public telephone network 24 to a non-integrated third party system, where it is received by a third party inbound workgroup 26. Second outbound call/conference call 22 transmits caller identification and ANI information to third party inbound workgroup 26, so that third party inbound workgroup 26 can identify the right party contact and access data from its own database pertinent to the right-party contact and the third party that third party inbound workgroup 26 represents.

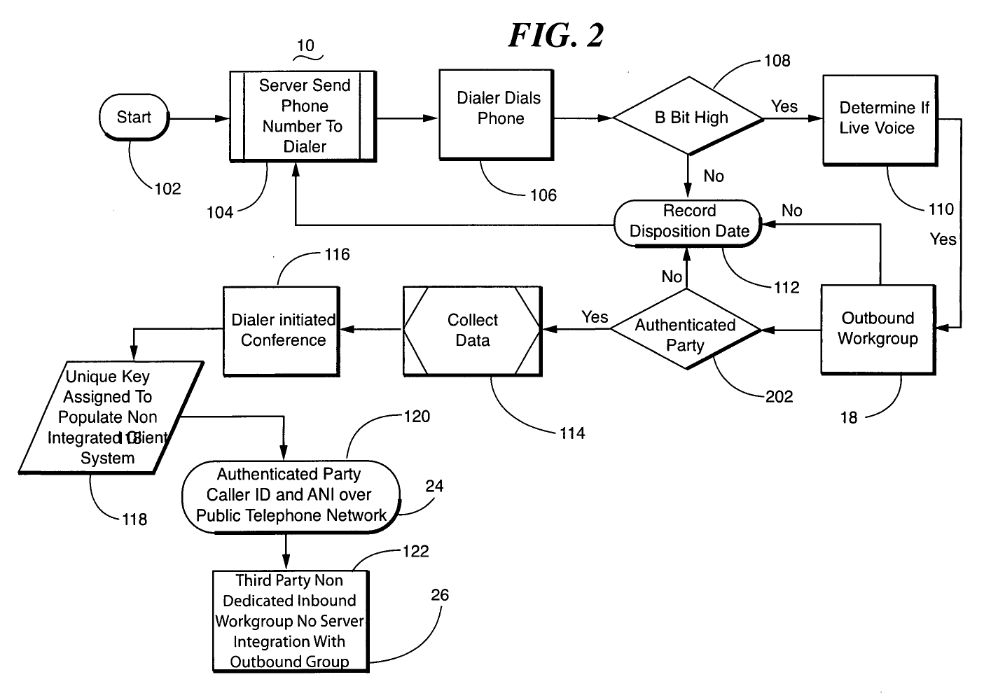

Referring now to FIG. 2, the representative embodiment of the present invention is illustrated through a flow-chart operation. As is shown in FIG. 2, once system 10 is started at start block 102, block 104 is initiated. At block 104, calling database 12 sends a telephone number to predictive dialer 14. Predictive dialer 14 dials the telephone number, beginning outbound call 16, at block 106. Once outbound call 16 is answered, predictive dialer 14 determines if the B bit is low or high at block 108. If the B bit is low, then outbound call 16 is terminated and disposition data is recorded in database 12 at block 112. If the B bit is high, then it is determined whether a live voice is present at block 110. If a live voice is absent, then outbound call 16 is terminated and disposition data is recorded in database 12 at block 112. However, if a live voice is present, outbound call 16 is connected to outbound workgroup 18.

As discussed above, call handler 19 of outbound workgroup 18 asks and obtains responses to the series of questions, with appropriate responses resulting in the party receiving outbound call 16 being deemed an authenticated party 20a. If the party receiving outbound call 16 is not deemed to be an authenticated party 20a, then outbound call 16 is terminated and disposition data is recorded in database 12 at block 112. A determination that the party is an authenticated party 20a results in data 13 being collected at block 114 and outbound call 16 being electronically routed back to predictive dialer 14.

At block 116, predictive dialer 14 initiates a second outbound call/conference call 22 over a public telephone network 24 to a non-integrated third party system, where it is received by a third party inbound workgroup 26 to connect call handler 19, right-party contact (authenticated party 20a), and third party inbound workgroup 26. As discussed above, a unique coding is preferably assigned to authenticated party 20a, shown at block 118. At block 120, second outbound call/conference call 22 transmits caller identification and ANI information to third party inbound workgroup 26, so that third party inbound workgroup 26 can identify the right-party contact and access data from its own database pertinent to the right-party contact and the third party that third party inbound workgroup 26 represents.

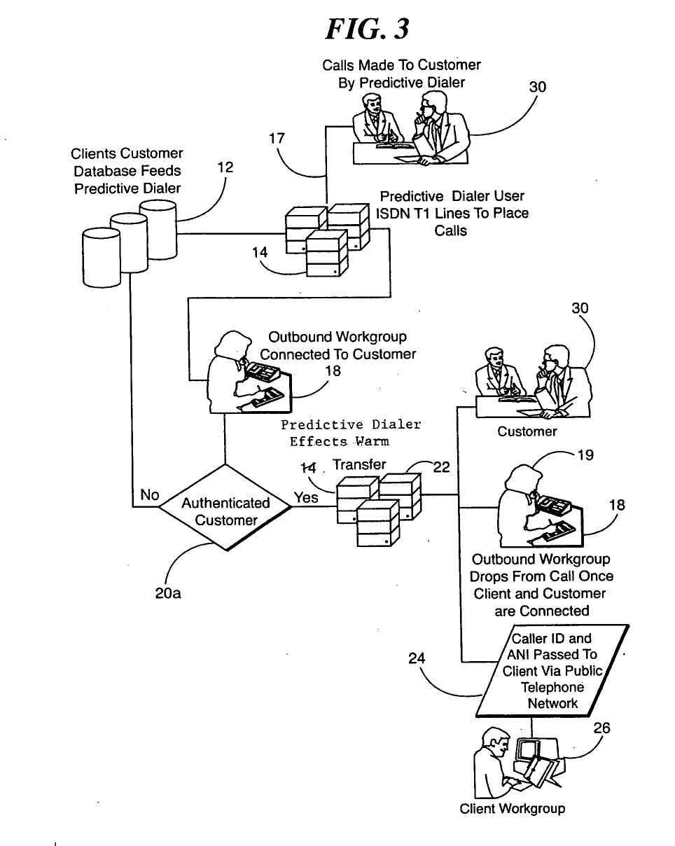

Referring now to FIG. 3, second outbound call/conference call 22 is further detailed. Second outbound call/conference call 22 connects the customer 30, which is also authenticated party 22a, to third party inbound workgroup 26, while keeping call handler 19 on the call. Once customer 30 and third party inbound workgroup 26 are connected, call handler 19 exits second outbound call/conference call 22, so as to effectuate a “warm” transfer of customer 30 to third party inbound workgroup 26. Via second outbound call/conference call 22, predictive dialer 14 transmits caller identification and coded ANI information to a non-integrated system of third party inbound workgroup 26 over a public telephone network. The caller identification and ANI information permit third party inbound workgroup 26 to utilize its own database, which is not integrated to database 12. Call routing system 10 of the present invention allows for itself to be non-integrated to a system of third party inbound workgroup 26 as a result of the use of coded ANI information as detailed above. Utilizing the cross-reference table created by call routing system 10 permits call routing system 10 and the non-integrated system of third party inbound workgroup 26 to have differing information for the same right-party contact.

Also within the invention is a method of regulating the pace at which the predictive dialer 14 places outbound calls. The higher the pacing rate and therefore the shorter the gap between any one person's (i.e., person in a workgroup) calls, the higher the probability of placing a call that cannot be serviced by a person in a workgroup. In other words, the number of calls the predictive dialer has to make is based on the number of conference calls that are busy. In a method of regulating the pace at which the predictive dialer 14 will place outbound calls, pacing of the outbound dialer 14 is controlled by initially allocating a designated number of conference call ports based on the quantity of staff at the inbound call group. The dialer 14 monitors the number of conference call ports in use at all times. The dialer 14 also monitors statistics of how many new dials result in a conference call (i.e., an authenticated transfer). The dialer 14 is able to predict and launch new outbound calls based on the number of conference call ports currently available. This method requires no computer connectivity between workgroups or sites.

Although only a few exemplary embodiments of the present invention have been described in detail above and in the following Figures, those skilled in the art will readily appreciate that numerous modifications to the exemplary embodiments are possible without materially departing from the novel teachings and advantages of this invention. Accordingly, all such modifications are intended to be included within the scope of this invention as defined in the following claims.

1. A system for routing outbound telephone calls between an outbound call workgroup and a third party, comprising:
a predictive dialer configured to dial a first outbound telephone call, said predictive dialer configured and arranged to route said first outbound telephone call placed by said dialer to an outbound call workgroup after a first voice authentication;
said outbound call workgroup performing a second voice authentication, wherein said outbound call workgroup identifies a right-party contact on said first outbound telephone call based upon said second voice authentication; and
wherein said predictive dialer dials a second outbound telephone call to said third party once said right-party contact on said first outbound telephone call is available to talk to said third party.

2. The system according to claim 1 wherein said first voice authentication results from a presence of a human voice.

3. The system according to claim 1 wherein said first outbound telephone call and said second outbound telephone call are separate telephone calls.

4. The system according to claim 1 wherein said second outbound telephone call places said outbound call workgroup, said third party, and said right-party contact in communication with one another.

5. A system for routing outbound telephone calls between an outbound call workgroup and a third party, comprising:
a predictive dialer configured to dial a first outbound telephone call, said predictive dialer configured and arranged to route said first outbound telephone call placed by said dialer to an outbound call workgroup after a first voice authentication;
said outbound call workgroup performing a second voice authentication, wherein
said outbound call workgroup identifies a right-party contact on said first outbound telephone call based upon said second voice authentication;
wherein said predictive dialer dials a second outbound telephone call to said third party once said right-party contact on said first outbound telephone call is available to talk to said third party; and
wherein said second outbound telephone call transmits caller identification and ANI information to said third party.

6. The system according to claim 5 wherein said third party identifies said right party accesses data from a third party database that is related to said right party.

7. A method for routing outbound telephone calls between an outbound call workgroup and a non-integrated call handling system of a third party, comprising:
identifying account information having a first account number;
creating a cross-reference table to code said first account number to a second account number;
providing said cross-reference table to said third party;
transmitting said second account number to said third party; and
decoding said second account number to said first account number by said third party.

8. The method according to claim 7 wherein said second account number incorporates caller identification and coded ANI information.

9. The method according to claim 7 wherein said second account number is transmitted over a public telephone network.

10. A system for connecting an outbound call workgroup, a right party contact and a non-integrated call handling system of a third party, having a predictive dialer configured to dial a first outbound telephone call, said predictive dialer configured and arranged to route said first outbound telephone call placed by said dialer to an outbound call workgroup after a first voice authentication, said outbound call workgroup performing a second voice authentication, wherein said outbound call workgroup identifies said right-party contact on said first outbound telephone call based upon said second voice authentication, said system comprising:
a second outbound telephone call generated by said predictive dialer to said third party once said right-party contact on said first outbound telephone call is available to talk to said third party;
wherein said second outbound telephone call places said outbound call workgroup, said third party, and said right-party contact in communication with one another.

11. The system of claim 10, wherein said second outbound telephone call transmits caller identification and ANI information to said third party.

12. A system for controlling the predictive dialing pacing algorithm based on the number of lines conferenced and connected to the third party compared to the number of available conference lines.
